(19) United States
(12) Patent Application Publication
(10) Pub. No.: US 2026/0040280 A1
(43) Pub. Date: Feb. 5, 2026

(54) SYSTEM AND SCHEME ON UNIFIED AND DUPLEXING-UNAWARE FRAME STRUCTURE

(71) Applicant: Huawei Technologies Co., Ltd., Shenzhen (CN)

(72) Inventors: Liqing Zhang, Ottawa (CA); Hao Tang, Ottawa (CA); Jianglei Ma, Ottawa (CA)

(21) Appl. No.: 19/355,647

(22) Filed: Oct. 10, 2025

Related U.S. Application Data
(63) Continuation of application No. PCT/CN2023/099714, filed on Jun. 12, 2023.
(60) Provisional application No. 63/458,452, filed on Apr. 11, 2023.

(51) Int. Cl. H04W 72/044; H04L 5/14; H04W 72/231

(52) U.S. Cl. CPC H04W 72/044; H04L 5/1469; H04W 72/231

(57) ABSTRACT

A method includes receiving a first parameter for a resource allocation, and communicating using resources in accordance with the resource allocation based on the first parameter. The first parameter comprises an indication of a carrier, an indication of a bandwidth part, an indication of a time domain resource, or an indication of a transmission direction.

### CROSS-REFERENCE TO RELATED APPLICATIONS

This application is a continuation of International Application No. PCT/CN2023/099714, filed on Jun. 12, 2023, which claims priority to U.S. Patent Application No. 63/458,452, filed on Apr. 11, 2023, both of which are hereby incorporated by reference in their entireties.

### TECHNICAL FIELD

The present disclosure relates, generally, to wireless communication networks and, in particular embodiments, to frame structures used in such networks and, further particularly, to a unified and duplexing-unaware frame structure.

### BACKGROUND

Current wireless communication networks are known to have complicated frame structure configurations. More particularly, it may be shown that time is consumed and power is consumed, at both a network end and a user equipment (UE) end of a communication channel, when configuration signaling is exchanged in an effort to configure a Time Division Duplex (TDD) operation mode. It may be shown that configuring of a TDD operation mode is carried out in an effort to maintain multi-level frame configurations.

Moreover, the network uses further signaling to configure UE operation, including a frequency (or multiple frequencies), a bandwidth part (or multiple bandwidth parts) and numerologies.

According to standards that specify a so-called new radio (NR) radio access technology, there are three-level frame structure configurations for TDD. These frame structure configurations may be considered to be relatively complicated. A slot format includes downlink symbols, uplink symbols and flexible symbols. The three-level frame structure configurations for TDD include semi-statically configured cell-common/cell-specific slot configuration parameters, such as tdd-UL-DL-ConfigurationCommon in ServingCellConfigCommon or ServingCellConfigCommonSIB, semi-statically configured UE-specific dedicated slot configuration parameters, such as tdd-UL-DL-ConfigurationDedicated in ServingCellConfig and UE-specific/UE-group-specific dynamic configuration or indication, such as SlotFormatIndicator, sfi-RNTI and a payload size of DCI format 2_0 by dci-PayloadSize.

These configuration parameters may be provided by a higher-layer signaling, such as radio resource control (RRC) signaling, and may be indicated by physical layer signaling or dynamic signaling, such as in downlink control information (DCI).

### SUMMARY

Aspects of the present application relate to flexible and unified frame structures. The frame structures that exemplify the present application may be shown to be applicable to a time-division duplexing operation mode, a frequency division duplexing operation mode and a full duplexing operation mode for next generation wireless networks. By considering the configuration simplification in combination with network power saving and user equipment power saving, these frame structures may be implemented on low-cost devices for receiving and transmitting traffic in applications related to sensing and in applications related to communications.

Current schemes for frame structure configuration may be considered to be complicated and may not be applicable to some devices in future networks, such as 6G networks, where low-power consumption and low-cost is preferred.

Aspects of the present application relate to schemes on frame structure configuration that are simpler than known schemes. By reducing complexity, aspects of the present application may be shown to be applicable to networks that have a preference for low-power consumption and low-cost.

According to an aspect of the present disclosure, there is provided a method. The method includes receiving a first parameter for a resource allocation and communicating using resources in accordance with the resource allocation based on the first parameter. The first parameter may be at least one of following parameters: an indication of a carrier; an indication of a bandwidth part; an indication of a time domain resource; and an indication of a transmission direction.

According to an aspect of the present disclosure, there is provided an apparatus. The apparatus includes at least one processor coupled to a memory storing computer-readable instructions, caused, by executing the computer-readable instructions, to receive a first parameter for a resource allocation and communicate using resources in accordance with the resource allocation based on the first parameter. The first parameter includes at least one of following parameters: an indication of a carrier; an indication of a bandwidth part; an indication of a time domain resource; and an indication of a transmission direction.

According to an aspect of the present disclosure, there is provided a non-volatile/non-transitory computer-readable medium storing instruction. The instructions, when executed by a processor, cause the processor to receive a first parameter for a resource allocation and communicate using resources in accordance with the resource allocation based on the first parameter. The first parameter comprises at least one of following parameters: an indication of a carrier; an indication of a bandwidth part; an indication of a time domain resource; and an indication of a transmission direction.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates an overview of a three-dimensional resource indication scheme, in accordance with aspects of the present application;

FIG. 7 illustrates an example of a plurality of BWP configuration sets for traffic reception and traffic transmission, in accordance with aspects of the present application;

FIG. 8 illustrates some examples of 5G frequency bands and band indices;

FIG. 9A illustrates frame structures, including a user equipment reception frame structure and a user equipment transmission frame structure, in accordance with aspects of the present application;

FIG. 9B illustrates sharing of spectrum in a bandwidth part, in accordance with aspects of the present application;

FIG. 10 illustrates two time-division duplex frame structures, in accordance with aspects of the present application; and

FIG. 11 illustrates a full duplex configuration and an frequency-division duplex configuration, in accordance with aspects of the present application.

### DETAILED DESCRIPTION OF THE ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

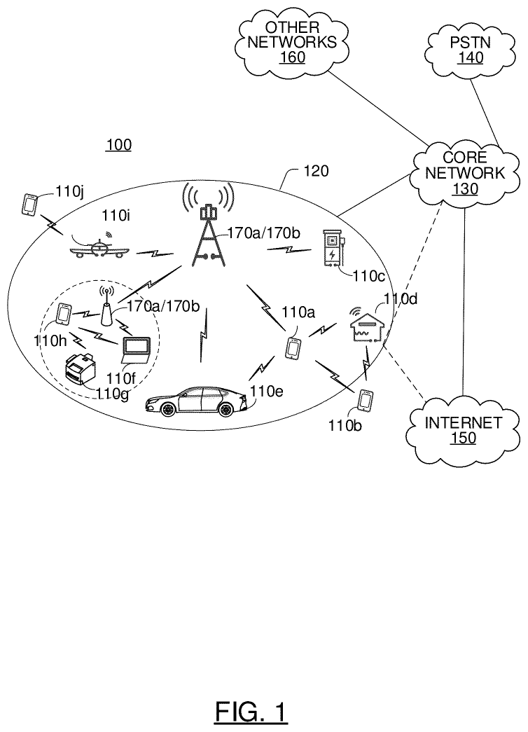

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

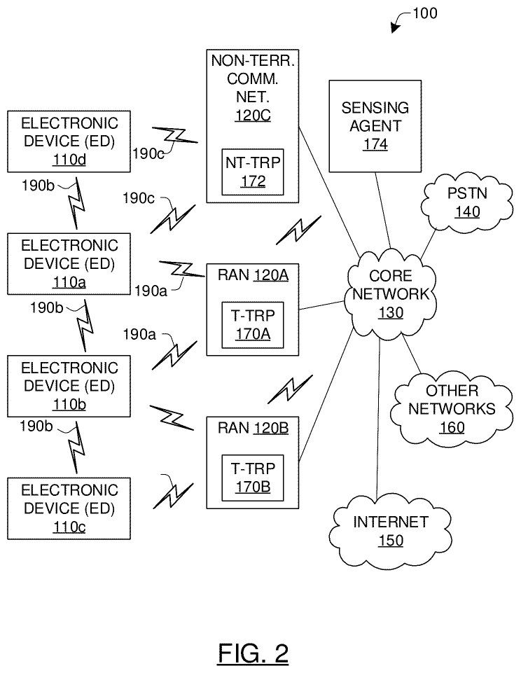

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

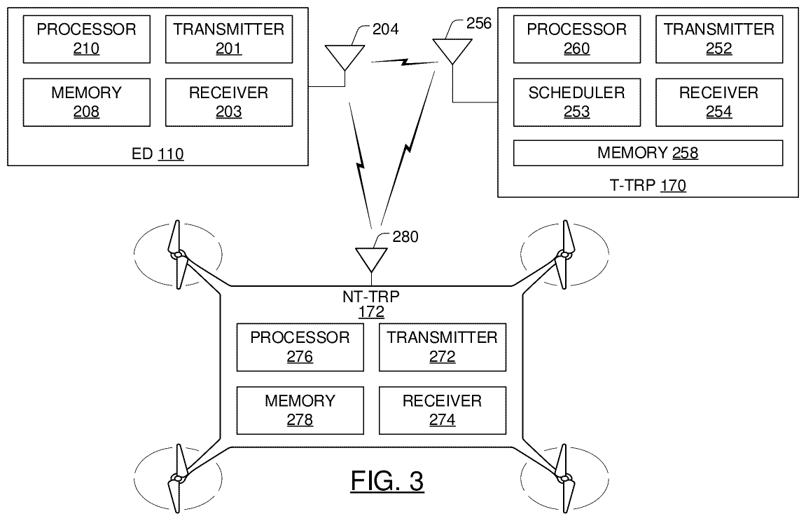

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

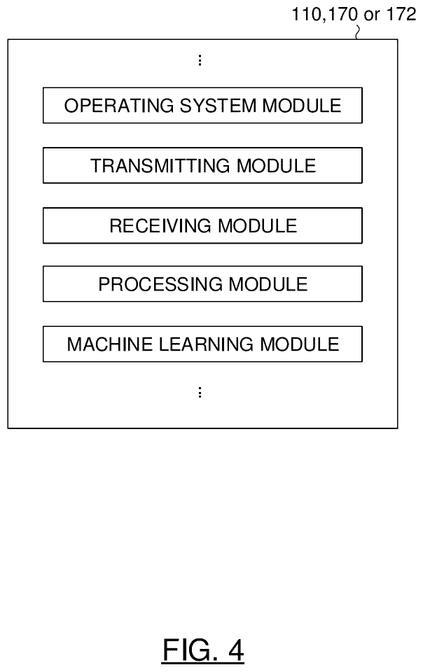

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

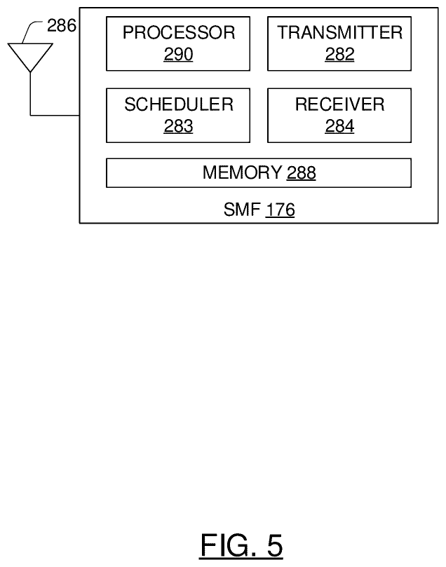

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chrip 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

Aspects of the present application relate to a flexible and unified frame structure, which may be applicable to a TDD operation mode, a FDD operation mode and a FD operation mode for next generation wireless network. By considering the configuration simplification, network power saving and UE power saving, aspects of the present application relate to a flexible and simplified configuration that may be used on low-cost devices for receiving and transmitting traffic in applications of sensing and communications.

For UE transmission and/or reception, communication parameters may comprise carrier, bandwidth part (BWP) and frame structure. These communication parameters may be grouped together for three-dimensional (3D) resource allocation. Based on a particular 3D resource allocation, time-frequency resources and other transmission parameters may be further configured or scheduled for the UE. For a given 3D resource indication, the UE is able to transmit or receive traffic in one or more symbols within a slot and/or frame over an operational BWP at a given carrier (including carrier band and carrier frequency). Moreover, a 3D resource indication may be shown to implicitly indicate a duplexing mode, among TDD, FDD, FD and sub-band full duplexing (SBFD). All of these duplexing modes may be shown to allow for a unified and duplexing unaware frame structure, which means that the configuration itself from network may indicate, to a UE, which one or more types of duplexing modes, including TDD, FDD, FD and SBFD, to apply in the UE transmission and reception. This is done by configuring so called 3D (see below) resource/parameter allocation such that the configuration information can indicate the transmission or reception characteristics, including one or more duplexing modes.

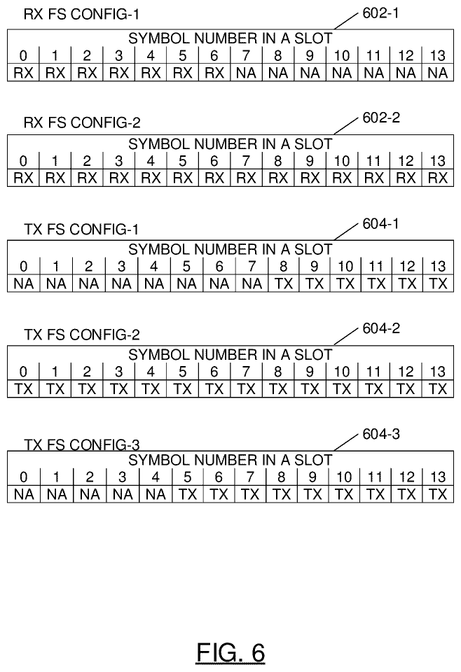

FIG. 6 illustrates an overview of a 3D resource indication scheme 600. The scheme 600 may be provided from a base station (BS) 170 to a UE 110 or to more than one UE 110. FIG. 6, as an example, illustrates two types (or categories) of frame structure (FS) configurations for UE reception: Rx FS config-1 602-1; and Rx FS config-2 602-2. Further Rx FS configurations may also be contemplated. FIG. 6 also illustrates three types (or categories) of FS configurations for UE transmission: Tx FS config-1 604-1; Tx FS config-2 604-2; and Tx FS config-3 604-3.

The Rx FS config-1 configuration 602-1 is representative of a slot having 14 symbols, numbered 0 to 13. In the Rx FS config-1 configuration 602-1, it may be noted that some of the numbered symbols in the slot are associated with the characters “Rx” and others of the numbered symbols in the slot are associated with the characters “NA.” It may be understood that symbols associated with the characters “Rx” are configured as being valid reception symbols. It may further be understood that symbols associated with the characters “NA” (for “not available”) are configured as being invalid reception symbols. Although, in the Rx FS config-1 configuration 602-1 of FIG. 6, the Rx symbols are clustered together in symbols 0-6 and the NA symbols are clustered together in symbols 7-13, it should be understood that the Rx symbols and the NA symbols may be configured in any symbol location.

In the Rx FS config-2 configuration 602-2, all symbols in a slot are configured as valid reception symbols.

The Rx FS config-1 configuration 602-1 and the Rx FS config-2 configuration 602-2 present two types of symbol, Rx and NA. A third type of symbol is also contemplated. The third type of symbol may be called a flexible symbol (not shown), where one or more flexible symbols can be configured or defined among symbols in Rx FS, or one or more of the “NA” symbols can be further configured as flexible symbol(s). A flexible symbol may be valid for reception or invalid for reception by configuration. Notably, in view of Tx FS configurations, discussed hereinafter, symbols configured as flexible may not also be designated for transmission.

In the Tx FS config-1 configuration 604-1, it may be noted that some of the numbered symbols in the slot are associated with the characters “Tx” and others of the numbered symbols in the slot are associated with the characters “NA.” It may be understood that symbols associated with the characters “Tx” are configured as being valid transmission symbols. It may further be understood that symbols associated with the characters “NA” (for “not available”) are configured as being invalid transmission symbols. Although, in the Tx FS config-1 configuration 604-1 of FIG. 6, the Tx symbols are clustered together in symbols 0-7 and the NA symbols are clustered together in symbols 8-13, and, in the Tx FS config-3 configuration 604-3 of FIG. 6, the Tx symbols are clustered together in symbols 5-13 and the NA symbols are clustered together in symbols 0-4, it should be understood that the Tx symbols and the NA symbols may be configured in any symbol location.

In the Tx FS config-2 configuration 604-2, all symbols in a slot are configured as valid transmission symbols.

In the Tx FS config-3 configuration 604-3, some symbols are configured as being valid transmission symbols (Tx) and some symbols are configured as being invalid transmission symbols (NA). Moreover, the symbols that are configured as being valid transmission symbols are illustrated as overlapping with symbols configured, by the Rx FS config-1 configuration 602-1, as valid reception symbols. In this way, the Tx FS config-3 configuration 604-3 differs from the Tx FS config-1 configuration 604-1.

The Tx FS config-1 configuration 604-1, the Tx FS config-2 configuration 604-2 and the Rx FS config-3 configuration 604-3 present two types of symbol, Tx and NA. A third type of symbol is also contemplated. The third type of symbol may be called a flexible symbol (not shown), where one or more flexible symbols can be configured or defined among symbols in Tx FS, or one or more of the “NA” symbols can be further configured as flexible symbol(s). A flexible symbol may be valid for transmission or invalid for transmission by configuration. Notably, in view of Rx FS configurations, discussed hereinbefore, symbols configured as flexible may not also be designated for reception.

For the purposes of carrier configuration, the 3D resource indication scheme 600 may comprise one or more indications of a carrier frequency band and/or one or more indications of a component carrier. Each distinct carrier frequency band and component carrier may be understood to be applicable to a distinct duplexing mode. For example. A first carrier, f₁, may be applicable to TDD, a second carrier, f₂, may be applicable to FD and a third carrier, f_{0_1}, and a fourth carrier, f_{0_0}, may be applicable to FDD, where these carriers may be inter-frequency bands and/or intra-frequency bands.

It follows that, in view of the definitions and configurations presented hereinbefore, a 3D resource indication scheme may be shown to map to a duplexing mode.

For a first example, a UE configuration of Rx: {RX BWP 2 (f₂), RX FS-2} and Tx: {TX BWP 2 (f₂), TX FS-2} may be understood to indicate an operation in FD mode.

For a second example, a UE configuration of Rx: {RX BWP 2 (f₂), RX FS-1} and Tx: {TX BWP 2 (f₂), TX FS-3} may be understood to indicate an operation in FD mode or SBFD mode.

For a third example, a UE configuration of Rx: {RX BWP 1 (f₁), RX FS-1} and Tx: {TX BWP 1 (f₁), TX FS-1} may be understood to indicate an operation in TDD mode.

For a fourth example, a UE configuration of Rx: {RX BWP 0 (f_{0_1}), RX FS-2} and Tx: {TX BWP 0 (f_{0_0}), TX FS-2} may be understood to indicate an operation in FDD mode.

Note that the notation {p1, p2} is used herein to represent a group of parameters (p1, p2) in terms of a BWP definition and other configuration details that are described in the following paragraphs. The notation may, of course, be expanded to suit the situation. For example, the notation {p1, p2, p3} may be used to represent a group of three parameters (p1, p2, p3).

In general, a multi-dimensional resource indication may be expected to include at least one of following parameters: an indication of a carrier; an indication of a bandwidth part; an indication of a time domain resource; and an indication of a transmission direction.

Moreover, a frame structure having a symbol resource or a symbol resource having a symbol timing boundary can be configured using a 3D resource indication, where the symbol timing boundary comprises a starting timing point for the symbol and an ending timing point for the symbol. The starting timing point for the symbol may be expressed relative to a timing reference point. Similarly, the ending timing point for the symbol may be expressed relative to a timing reference point. The timing reference point may be a standard reference time instant and/or an absolute time reference. The absolute time reference may, for two examples among many, be a GPS-based absolute time reference or a cell-based absolute time reference.

A given 3D resource indication may configured in a semi-static way, e.g., via radio resource control signaling or via MAC-CE. Alternatively, a given 3D resource indication may configured in a dynamic way, e.g., via downlink control information.

In the 3D resource indication scheme representative of aspects of the present application, the indication of the transmission direction may be implemented as an indication of a downlink transmission direction and/or as an indication of an uplink transmission direction. The indication of the transmission direction corresponds to a portion of the time domain resource or the indication of the transmission direction corresponds to an entirety of the time domain resource.

Furthermore or alternatively, DL frames and UL frames may be time aligned or realigned with a timing refence point for TDD operation. The timing reference point may be a standard reference time instant and/or an absolute time reference. The absolute time reference may, for two examples among many, be a GPS-based absolute time reference or a cell-based absolute time reference.

Aspects of the present application relate to defining and configuring BWP sets among available carriers.

A Tx BWP set may reference Tx BWP indices from 0 to N−1 over applicable uplink (UL) frequency band(s) and carrier component(s), where N≥1.

An Rx BWP set may reference Rx BWP indices from 0 to M−1 over applicable downlink (DL) frequency band(s) and carrier component(s), where M≥1.

A BWP configuration may reference a carrier frequency (e.g., a center frequency and frequency bandwidth of a carrier in which the BWP is located) and a component carrier (CC) within the carrier. The BWP may have a configured transmission bandwidth that represents the entirety of, or part of, a channel bandwidth of the CC.

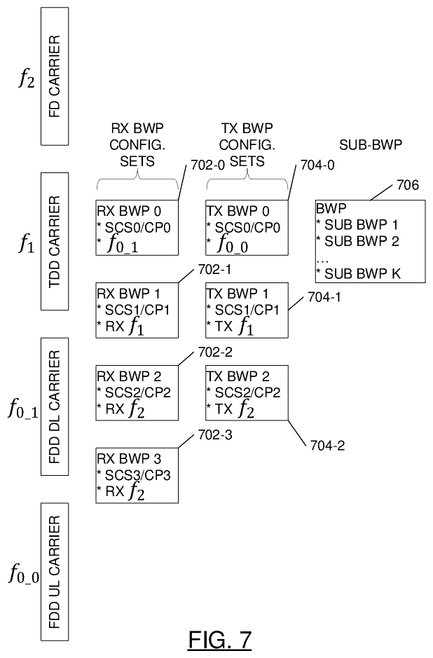

FIG. 7 illustrates an example of a plurality of BWP configuration sets for traffic reception (Rx) and traffic transmission (Tx). A given UE may be configured with one BWP configuration set or a plurality of BWP configuration sets. Such configuration may be carried out by a generic network element or by a BS 170.

FIG. 7, as an example, illustrates four Rx BWP configuration sets (collectively or individually associated with reference numeral 702) including: a zeroth Rx BWP configuration set (Rx BWP 0) 702-0; a first Rx BWP configuration set (Rx BWP 1) 702-1; a second Rx BWP configuration set (Rx BWP 2) 702-2; and a third Rx BWP configuration set (Rx BWP 3) 702-3. The zeroth Rx BWP configuration set 702-0 includes an indication of a DL subcarrier spacing (SCS0), an indication of a DL cyclic prefix (CP0) and an indication of a reception (Rx) carrier, f_{0_1}. The first Rx BWP configuration set 702-1 includes an indication of a DL subcarrier spacing (SCS1), an indication of a DL cyclic prefix (CP1) and an indication of a Rx carrier, f₁. The second Rx BWP configuration set 702-2 includes an indication of a DL subcarrier spacing (SCS2), an indication of a DL cyclic prefix (CP2) and an indication of a Rx carrier, f₂. The third Rx BWP configuration set 702-3 includes an indication of a DL subcarrier spacing (SCS3), an indication of a DL cyclic prefix (CP3) and an indication of a Rx carrier, f₂, where the values of subcarrier spacing SCS1, SC2 and SCS3 may or may not be same.

One UE may work in, or support, one or more frequency bands. The frequency bands may be in a lower frequency range (FR) and in a higher frequency range. For example, two frequency ranges, referenced as “FR1” and “FR2,” are known to be defined for 5G wireless communication. FR1, also known as the sub-6 GHz frequency range, covers frequencies between 450 MHz and 6 GHz. FR1 is considered to be the foundational frequency range for 5G, providing wide coverage and better-than-FR2 penetration through obstacles like walls and buildings. FR2, on the other hand, is also known as the millimeter wave (mmWave) frequency range. FR2 covers frequencies between 24 GHz and 52.6 GHz. FR2 may be considered to provide a much larger bandwidth than FR1, enabling faster data rates for 5G networks. However, mmWave frequencies have limited coverage and are easily blocked by obstacles. The limited coverage of FR2 may be overcome through configuration of a network infrastructure that is denser than the network infrastructure used with FR1.

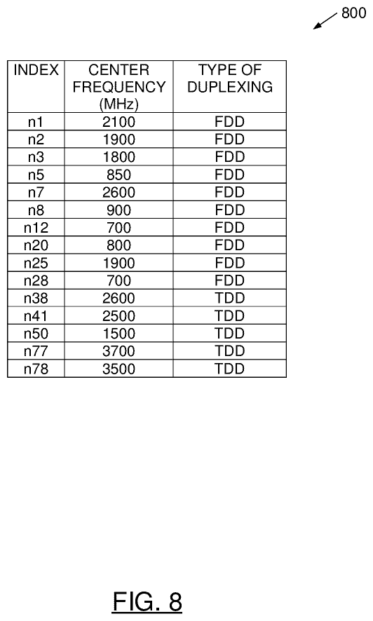

FIG. 8 illustrates some examples of 5G frequency bands and band indices.

FDD technology is known to involve dividing an available spectrum into two different frequency bands; one frequency band for uplink communication and one frequency band for downlink communication.

The frequency bands used for FDD include the n1 band. The n1 band is known to operate in a frequency range of 1920-1980 MHz for uplink and in a frequency range of 2110-2170 MHz for downlink. The n1 band is known to be commonly used in North America, Latin America and some other regions.

The frequency bands used for FDD include the n2 band. The n2 band is known to operate in a frequency range of 1850-1910 MHz for uplink and in a frequency range of 1930-1990 MHz for downlink. The n2 band is known to be used in North America.

The frequency bands used for FDD include the n3 band. The n3 band is known to operate in a frequency range of 1710-1785 MHz for uplink and in a frequency range of 1805-1880 MHz for downlink. The n3 band is known to be commonly used in Europe, Africa and other regions.

The frequency bands used for FDD include the n5 band. The n5 band is known to operate in a frequency range of 824-849 MHz for uplink and in a frequency range of 869-894 MHz for downlink. The n5 band is known to be commonly used in Asia, Oceania and other regions.

The frequency bands used for FDD include the n7 band. The n7 band is known to operate in a frequency range of 2500-2570 MHz for uplink and in a frequency range of 2620-2690 MHz for downlink. The n7 band is known to be commonly used in Asia and Oceania.

In contrast to FDD technology, TDD technology is known to use the same frequency band for both uplink transmission and downlink transmission. In TDD technology, different time slots are allocated to each transmission direction. TDD technology is commonly used in LTE (4G) and 5G cellular networks. TDD frequency bands used in LTE and 5G networks vary by region and are typically licensed by governments or regulatory bodies.

The frequency bands used for TDD include the n41 band. The n41 band is known to operate in a frequency range of 2496-2690 MHz. The n41 band is known to be commonly used in China, Europe and other regions.

The frequency bands used for TDD include the n77 band. The n77 band is known to operate in a frequency range of 3300-4200 MHz. The n77 band is known to be commonly used in India, Australia and other regions.

The frequency bands used for TDD include the n78 band. The n78 band is known to operate in a frequency range of 3300-3800 MHZ. The n78 band is known to be commonly used in Europe and other regions.

The frequency bands used for TDD include the n79 band. The n79 band is known to operate in a frequency range of 4400-5000 MHz. The n79 band is known to be commonly used in Japan and other regions.

The frequency bands used for TDD include the n94 band. The n94 band is known to operate in a frequency range of 3400-3600 MHz. The n94 band is known to be commonly used in China.

5G wireless communication networks may take advantage of the features offered by high frequency bands (e.g., FR2). More particularly, 5G wireless communication networks may take advantage of the features offered by mmWave frequency bands. The 5G mmWave (millimeter-wave) frequency bands are known to be a set of high-frequency bands that are used for 5G wireless communication networks. 5G mmWave frequency bands may be characterized by a relatively high-frequency and a relatively short-range nature, which may be shown to make 5G mmWave frequency bands well-suited for use in urban areas. Indeed, urban areas may be characterized by relatively high-density populations and relatively high demand for data. In the United States, the Federal Communications Commission (FCC) has allocated several mmWave frequency bands for 5G use, including: 24.25-29.5 GHZ (n257); 37-40 GHz (n260); 47.2-48.2 GHz (n261); 71-76 GHz (unofficially referred to as n255); and 81-86 GHz (unofficially referred to as n262).

In aspects of the present application, a UE may be configured with one or more reception frame structures, for example, see the 3D resource indication scheme 600 of FIG. 6, and with one or more configuration sets for UE reception, for example, see the BWP configuration sets 702 of FIG. 7.

The zeroth Rx BWP configuration set 702-0 may be understood to be an FDD configuration set. The zeroth Rx BWP configuration set 702-0 is illustrated as including an indication of a frequency band, f_{0_1}. The indication may, for example, be implemented as an indication of a band index, e.g., band index n7 for downlink, for which frequency band f_{0_1}=2620-2690 MHz. Although not illustrated, the zeroth Rx BWP configuration set 702-0 may include an indication of a particular CC with channel bandwidth, for example, CC1 with 20 MHz in the frequency band, f_{0_1}. The zeroth Rx BWP configuration set 702-0 may include an indication of a sub-band or a bandwidth part (BWP) within the particular CC with transmission bandwidth, such as 10 MHz within CC1. Although not illustrated, the zeroth Rx BWP configuration set 702-0 may include an indication of specific sub-BWP that are part of the indicated BWP. Each sub-BWP may be understood to be one portion of the BWP, such as a 10^{th} of the BWP. Additionally, each sub-BWP may be understood to be associated with an index. The zeroth Rx BWP configuration set 702-0 is illustrated as including an indication of a SCS. The indicated SCS may be an SCS selected from among a plurality of available SCSs. In the case of FR1, it is known that the plurality of available SCSs includes 15 kHz and 30 kHz. The zeroth Rx BWP configuration set 702-0 is illustrated as including an indication of a type for the CP. The type of CP may, for example, be normal CP or extended CP.

The first Rx BWP configuration set 702-1 may be understood to be a TDD configuration set. The first Rx BWP configuration set 702-1 is illustrated as including an indication of a frequency band, f₁. The indication may, for example, be implemented as an indication of a band index, e.g., band index n41, for which frequency band, f₁=2496-2690 MHz. Although not illustrated, the first Rx BWP configuration set 702-1 may include an indication of a particular CC with channel bandwidth, for example, CC1 with 60 MHz in the frequency band, f₁. Although not illustrated, the first Rx BWP configuration set 702-1 may include an indication of a sub-band or a BWP within the particular CC with transmission bandwidth, such as 20 MHz within CC1. Although not illustrated, the first Rx BWP configuration set 702-1 may include an indication of specific sub-BWP that are part of the indicated BWP. Each sub-BWP may be understood to be one portion of the BWP, such as a 10^{th} of the BWP. Additionally, each sub-BWP may be understood to be associated with an index. The first Rx BWP configuration set 702-1 is illustrated as including an indication of a SCS. The indicated SCS may be an SCS selected from among a plurality of available SCSs. In the case of FR1, it is known that the plurality of available SCSs includes 15 kHz and 30 kHz. The first Rx BWP configuration set 702-1 is illustrated as including an indication of a type for the CP. The type of CP may, for example, be normal CP or extended CP.

The second Rx BWP configuration set 702-2 may be understood to be a high frequency band configuration set. The second Rx BWP configuration set 702-2 is illustrated as including an indication of a frequency band, f₂. The indication may, for example, be implemented as an indication of a band index, e.g., band index n257, for which frequency band, f₂=24.25-29.5 GHz. Although not illustrated, the second Rx BWP configuration set 702-2 may include an indication of a particular CC with channel bandwidth, for example, CC1 with 500 MHz in the frequency band, f₂. Although not illustrated, the second Rx BWP configuration set 702-2 may include an indication of a sub-band or a BWP within the particular CC with transmission bandwidth, such as 100 MHz within CC1. Although not illustrated, the second Rx BWP configuration set 702-2 may include an indication of specific sub-BWP that are part of the indicated BWP. Each sub-BWP may be understood to be one portion of the BWP, such as a 10th of the BWP. Additionally, each sub-BWP may be understood to be associated with an index. The second Rx BWP configuration set 702-2 is illustrated as including an indication of a SCS. The indicated SCS may be an SCS selected from among a plurality of available SCSs. In the case of FR2, it is known that the plurality of available SCSs includes 60 kHz. In the case of other frequency ranges, it is known that the plurality of available SCSs includes 240 kHz. The second Rx BWP configuration set 702-2 is illustrated as including an indication of a type for the CP. The type of CP may, for example, be normal CP or extended CP.

FIG. 7, as an example, illustrates three Tx BWP configuration sets (collectively or individually associated with reference numeral 704), including: a zeroth Tx BWP configuration set (Tx BWP 0) 704-0; a first Tx BWP configuration set (Tx BWP 1) 702-1; and a second Tx BWP configuration set (Tx BWP 2) 704-2. The zeroth Tx BWP configuration set 704-0 includes an indication of an UL subcarrier spacing (SCS0), an indication of an UL cyclic prefix (CP0) and an indication of a transmission (Tx) carrier, f_{0_0}. The first Tx BWP configuration set 704-1 includes an indication of an UL subcarrier spacing (SCS1), an indication of an UL cyclic prefix (CP1) and an indication of a Tx carrier, f₁. The second Tx BWP configuration set 704-2 includes an indication of an UL subcarrier spacing (SCS2), an indication of an UL cyclic prefix (CP2) and an indication of a Tx carrier, f₂, where the values of subcarrier spacing SCS1 and SC2 may or may not be same.

In these Tx BWP configuration sets, the SCS can be one of 15 kHz, 30 kHz, 60 kHz, 120 kHz, 240 kHz, 480 kHz and 960 kHz. If no SCS is configured, a default SCS may be assumed; for example, the default SCS may be 15 kHz. In these Tx BWP configuration sets, the CP may be extended CP or normal CP. These two possibilities are consistent with the known 5G NR standard. If no CP is configured, a default CP may be assumed; for example, the default CP may be normal CP.

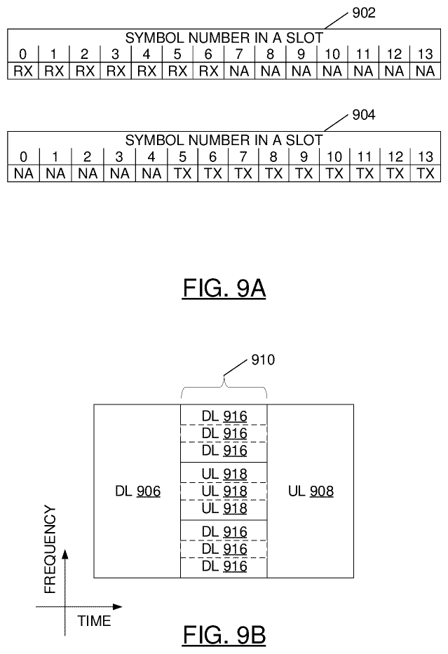

FIG. 7 illustrates a BWP 706. It is noted that the BWP 706 may be defined in terms of a carrier (e.g., a carrier frequency band and a CC). The BWP 706 may be divided into one or more (K≥1) sub-BWPs, either equally or un-equally, as a sub-BWP 1, a sub-BWP 2, . . . , and a sub-BWP K. A given sub-BWP may be indexed. Indexing of sub-BWPs may be shown to facilitate activating or deactivating a sub-BWP to support, e.g., power saving, reduced (scheduling) signaling, carrier aggregation, as well as operation in an SBFD mode. In the SBFD mode, spectrum within a BWP is shared for both transmitting and receiving in same symbols of same slots. The SBFD mode is discussed further, hereinafter, with reference to FIG. 9B.

The zeroth Tx BWP configuration set 704-0 may be understood to be an FDD configuration set. The zeroth Tx BWP configuration set 704-0 is illustrated as including an indication of a frequency band, f_{0_0}. The indication may, for example, be implemented as an indication of a band index, e.g., band index n7 for uplink, for which the frequency band, f_{0_0}=2620-2690 MHz. Although not illustrated, the zeroth Tx BWP configuration set 704-0 may include an indication of a particular CC with channel bandwidth, for example, CC2 with 20 MHz in the frequency band, f_{0_0}. Although not illustrated, the zeroth Tx BWP configuration set 704-0 may include an indication of a sub-band or a BWP within the particular CC with transmission bandwidth, such as 10 MHz within CC2. Although not illustrated, the zeroth Tx BWP configuration set 704-0 may include an indication of specific sub-BWP bands that are part of the indicated BWP. Each sub-BWP band may be understood to be one portion of the BWP, such as a 10^{th} of the BWP. Additionally, each sub-BWP band may be understood to be associated with an index. The zeroth Tx BWP configuration set 704-0 is illustrated as including an indication of a SCS. The indicated SCS may be an SCS selected from among a plurality of available SCSs. In the case of FR1, it is known that the plurality of available SCSs includes 15 kHz and 30 kHz. The zeroth Tx BWP configuration set 704-0 is illustrated as including an indication of a type for the CP. The type of CP may, for example, be normal CP or extended CP.

The first Tx BWP configuration set 704-1 may be understood to be a TDD configuration set. The first Tx BWP configuration set 704-1 is illustrated as including an indication of a frequency band, f₁. The indication may, for example, be implemented as an indication of a band index, e.g., band index n41, for which the frequency band, f₁=2496-2690 MHz. Although not illustrated, the first Tx BWP configuration set 704-1 may include an indication of a particular CC with channel bandwidth, for example, CC1 with 60 MHz in f₁. Although not illustrated, the first Tx BWP configuration set 704-1 may include an indication of a sub-band or a BWP within the particular CC with transmission bandwidth, such as 20 MHz within CC1. Although not illustrated, the first Tx BWP configuration set 704-1 may include an indication of specific sub-BWP bands that are part of the indicated BWP, each sub-BWP band may be understood to be one portion of the BWP such as 10^{th} of the BWP. Additionally, each sub-BWP band may be understood to be associated with an index. The first Tx BWP configuration set 704-1 may include an indication of a SCS. The indicated SCS may be an SCS selected from among a plurality of available SCSs. In the case of FR1, it is known that the plurality of available SCSs includes 15 kHz and 30 kHz. The first Tx BWP configuration set 704-1 is illustrated as including an indication of a type for the CP. The type of CP may, for example, be normal CP or extended CP.

The second Tx BWP configuration set 704-2 may be understood to be a high frequency band configuration set. The second Tx BWP configuration set 704-2 is illustrated as including an indication of a frequency band, f₂. The indication may, for example, be implemented as an indication of a band index, e.g., band index n257, for which frequency band, f₂=24.25-29.5 GHz. Although not illustrated, the second Tx BWP configuration set 704-2 may include an indication of a particular CC with channel bandwidth, for example, CC1 with 500 MHz in f₂. Although not illustrated, the second Tx BWP configuration set 704-2 may include an indication of a sub-band or a BWP within the particular CC with transmission bandwidth, such as 100 MHz within CC1. Although not illustrated, the second Tx BWP configuration set 704-2 may include an indication of specific sub-BWP bands that are part of the indicated BWP, each sub-BWP band may be understood to be one portion of the BWP such as 10^{th} of the BWP. Additionally, each sub-BWP band may be understood to be associated with an index. The second Tx BWP configuration set 704-2 is illustrated as including an indication of a SCS. The indicated SCS may be an SCS selected from among a plurality of available SCSs. In the case of FR2, it is known that the plurality of available SCSs includes 60 kHz. In the case of other frequency ranges, it is known that the plurality of available SCSs includes 240 kHz. The second Tx BWP configuration set 704-2 is illustrated as including an indication of a type for the CP. The type of CP may, for example, be normal CP or extended CP.

It may be shown that sub-BWPs have smaller granularities in frequency domains. Each sub-BWP may be semi-statically configured while activated or while deactivated in a dynamic or semi-static way, as described hereinafter. Accordingly, spectrum may be shared, or usage may be managed, on an on-demand basis. This approach may be shown to allow for increased economic spectrum usage and/or improved power saving relative to known approaches. Recall that, in general, a Tx BWP configuration set 704 may reference Tx BWP indices from 0 to N−1 over applicable UL frequency bands and carrier components.

Aspects of the present application relate to addressing sub-band/BWP full duplexing. Given that a BWP is to be divided into one or more (K≥1) sub-BWPs, the Rx FS config-1 configuration 602-1 or the Rx FS config-2 configuration 602-2 (see FIG. 6) may include sub-BWP configurations for one or more symbols. Also, the Tx FS config-1 configuration 604-1, the Tx FS config-2 configuration 604-2 and the Tx FS config-3 configuration 604-3 may include sub-BWP configurations for one or more symbols.

BWP/sub-BWP full duplexing in a same BWP spectrum over a symbol may involve use of an option selected from among the following three options: fully shared BWP; partially shared BWP; and sub-BWPs DL and UL orthogonal.

FIG. 9A illustrates frame structures, including a UE Rx FS 902 and a UE Tx FS 904. Notably, symbols 5 and 6 of the UE Rx FS 902 are designated for traffic reception and symbols 5 and 6 of the UE Tx FS 904 are designated for traffic transmission. Accordingly, symbols 5 and 6 are representative of symbols for which traffic reception and traffic transmission share spectrum in a BWP. Notably, DL sub-BWPs in the BWP and UL sub-BWPs in the BWP may be activated or deactivated.

FIG. 9B illustrates sharing of spectrum in a BWP. FIG. 9B illustrates three BWPs. A first BWP 906 is entirely associated with DL communication. A third BWP 908 is entirely associated with UL communication. A second BWP 910 is divided into a plurality of sub-BWPs. One or more DL sub-BWPs 916, when activated, are associated with DL communication. One or more UL sub-BWPs 918, when activated, are associated with UL communication.

Such activation and deactivation may be shown to allow for traffic reception and traffic transmission using one of the above three options. Using one of the options, for example, by activating (or deactivating) the DL sub-BWPs 916 and the UL sub-BWPs 918 in a non-overlapping way, sub-BWP duplexing in the second BWP 910 can be orthogonal in the symbols 5 and 6 with the time slot.

More generally, the DL BWP 906 (with the UE Rx FS 902) and the UL BWP 908 (with the UE Tx FS 904) may be partially overlapped. The partially overlapped bandwidth for the DL BWP 906 and the UL BWP 908 may each include one or more sub-BWPs, the DL sub-BWP 916 and the UL sub-BWP 918. The DL sub-BWP 916 and the UL sub-BWP 918 may be activated and/or deactivated to realize spectrum sharing with one of the above three options.

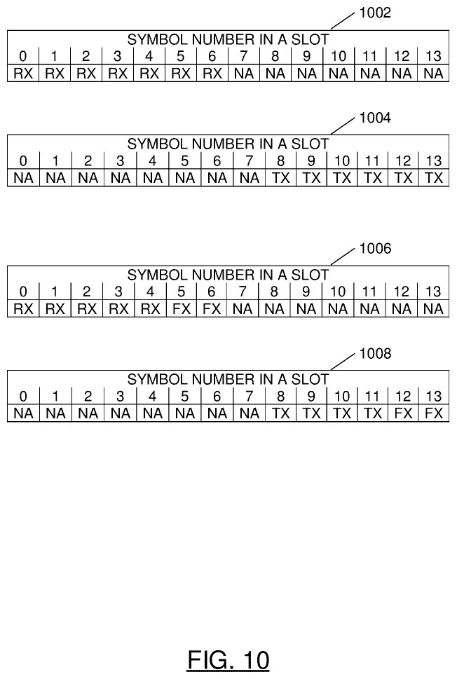

Aspects of the present application relate to addressing configurable numerology and flexible symbols, using TDD frame structures as an example. Flexible symbols are marked with Fx for UE Rx frame structure or UE Tx frame structure as shown in FIG. 10. FIG. 10 illustrates two TDD frame structures. A first TDD frame structure 1000-1 includes a first Rx FS 1002-1 and a first Tx FS 1004-1. A second TDD frame structure 1000-2 includes a second Rx FS 1002-1 and a second Tx FS 1004-1.

In the first TDD frame structure 1000-1, the first Rx FS 1002-1 includes a plurality of symbols labeled “Rx” and a plurality of symbols labeled “NA.” Similarly, the first Tx FS 1004-1 includes a plurality of symbols labeled “Tx” and a plurality of symbols labeled “NA.” Notably, none of the symbols labeled “Rx” in the first Rx FS 1002-1 are also labeled “Tx” in the first Tx FS 1004-1.

In the second TDD frame structure 1000-2, the second Rx FS 1002-2 includes a plurality of symbols labeled “Rx,” a plurality of symbols labeled “NA” and a plurality of symbols labeled “Fx.” Similarly, the second Tx FS 1004-2 includes a plurality of symbols labeled “Tx,” a plurality of symbols labeled “NA” and a plurality of symbols labeled “Fx.” Notably, none of the symbols labeled “Rx” in the second Rx FS 1002-2 are also labeled “Tx” in the second Tx FS 1004-2.

A symbol labeled “Fx” may be understood to be representative of a flexible symbol. In the context of the second Tx FS 1004-2, a flexible symbol may be defined as either a symbol that is available as a transmitting symbol or a symbol that is not available as a transmitting symbol. Notably, a flexible symbol in the second Tx FS 1004-2 may not be allowed to receive anything. In the context of the second Rx FS 1002-2, a flexible symbol may be defined as either a symbol that is available as a receiving symbol or a symbol that is not available as a receiving symbol. Notably, a flexible symbol in the second Rx FS 1002-2 may not be allowed to transmit anything.

As SCS and CP are parameters that can be configured in a BWP configuration for any frame structure (e.g., duplexing mode of FD, TDD, FDD, with DL, UL, etc.), different frame structures for different duplexing modes or for DL and UL may have different numerologies in terms of different SCSs and CPs. The SCS may be one of 15 kHz, 30 kHz, 60 kHz, 120 kHz, 240 kHz, 480 kHz and 960 kHz. If no SCS is configured, a default SCS may be assumed; for example, the default SCS may be 15 kHz. The CP may be extended CP or normal CP. These two possibilities are consistent with the known 5G NR standard. If no CP is configured, a default CP may be assumed; for example, the default CP may be normal CP.

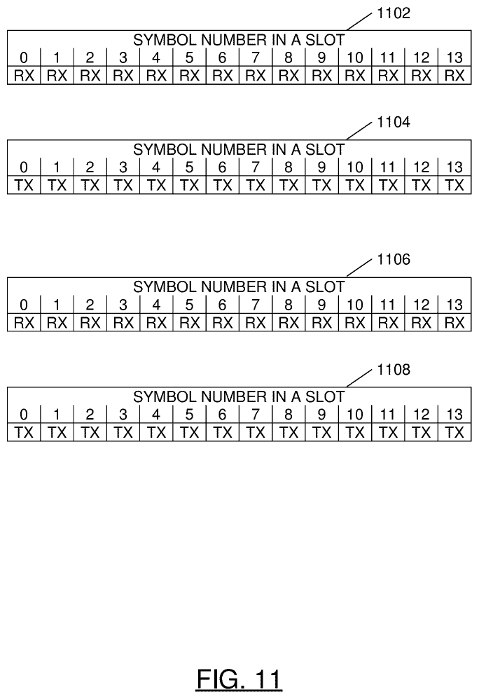

FIG. 11 illustrates an FD configuration 1100-1 and an FDD configuration 1100-2, according to aspects of the present application.

For the FD configuration 1100-1, an FD UE Rx FS 1102-1 is configured with a Rx BWP (in band f₂) and an FD UE Tx FS 1104-1 is configured with a Tx BWP (in band f₂).

For the FDD configuration 1100-2, an FDD UE Rx FS 1102-2 is configured with an Rx carrier (in band f_{0_1}) with an i^{th} BWP and an FDD UE Tx FS 1104-2 is configured with a Tx carrier (in band f_{0_0}) with a j^{th} BWP. Notably, SCS and CP are absent from the configurations, which means that a default SCS (e.g., 15 kHz) and a default CP (e.g., normal CP) may be commonly configured or defined for all frame structures.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
receiving a first parameter for a resource allocation; and
communicating using resources in accordance with the resource allocation based on the first parameter; and
receiving a second parameter used for configuring a symbol resource with a symbol timing boundary; and
wherein the first parameter comprises at least one of following parameters:
an indication of a carrier;
an indication of a bandwidth part;
an indication of a time domain resource; or
an indication of a transmission direction.

2. The method of claim 1, wherein the symbol timing boundary comprises a starting timing point for a symbol.

3. The method of claim 1, wherein the symbol timing boundary comprises an ending timing point for a symbol.

4. The method of claim 1, wherein the second parameter is included in downlink control information signaling.

5. The method of claim 1, wherein the first parameter relates to resource allocation in a downlink transmission direction and in an uplink transmission direction.

6. An apparatus comprising:
at least one processor coupled to a memory storing computer-readable instructions, wherein the apparatus is caused, by executing the computer-readable instructions, to:
receive a first parameter for a resource allocation;
communicate using resources in accordance with the resource allocation based on the first parameter; and
receiving a second parameter used for configuring a symbol resource with a symbol timing boundary; and
wherein the first parameter comprises at least one of following parameters:
an indication of a carrier;
an indication of a bandwidth part;
an indication of a time domain resource; or
an indication of a transmission direction.

7. The apparatus of claim 6, wherein the symbol timing boundary comprises a starting timing point for a symbol.

8. The apparatus of claim 6, wherein the symbol timing boundary comprises an ending timing point for a symbol.

9. The apparatus of claim 6, wherein the second parameter is included in downlink control information signaling.

10. The apparatus of claim 6, wherein the first parameter relates to resource allocation in a downlink transmission direction and in an uplink transmission direction.

11. The apparatus of claim 6, wherein the first parameter is included in downlink control information signaling.

12. An apparatus comprising:
at least one processor coupled to a memory storing computer-readable instructions, wherein the apparatus is caused, by executing the computer-readable instructions, to:
transmit a first parameter for a resource allocation;
communicate using resources in accordance with the resource allocation; and
transmit a second parameter used for configuring a symbol resource with a symbol timing boundary; and
wherein the first parameter comprises at least one of following parameters:
an indication of a carrier;
an indication of a bandwidth part;
an indication of a time domain resource; or
an indication of a transmission direction.

13. The apparatus of claim 12, wherein the symbol timing boundary comprises a starting timing point for a symbol.

14. The apparatus of claim 12, wherein the symbol timing boundary comprises an ending timing point for a symbol.

15. The apparatus of claim 12, wherein the second parameter is included in downlink control information signaling.

16. The apparatus of claim 12, wherein the first parameter relates to resource allocation in a downlink transmission direction and in an uplink transmission direction.

17. The apparatus of claim 12, wherein the first parameter is included in downlink control information signaling.
